(19) United States
(12) Patent Application Publication
(10) Pub. No.: US 2024/0217521 A1
(43) Pub. Date: Jul. 4, 2024

(54) VIRTUAL TRACK DETECTION SYSTEM AND METHOD

(71) Applicant: Automotive Research & Testing Center, Lugang (TW)

(72) Inventors: Yi-Cheng Chen, Lugang (TW); Yun-Ling Chang, Lugang (TW); I-Chun Kuo, Lugang (TW)

(73) Assignee: Automotive Research & Testing Center, Lugang (TW)

(21) Appl. No.: 18/089,857

(22) Filed: Dec. 28, 2022

(51) Int. Cl. B60W 40/072; G06V 20/56

(52) U.S. Cl. CPC B60W 40/072; G06V 20/588; B60W 2420/42; B60W 2552/30; B60W 2552/53

(57) ABSTRACT

A virtual track detection system and method is disclosed, wherein a track pattern is drawn on a track and positioning elements is disposed along a curved section of the track. The method includes steps: capturing front road images; recognizing the track pattern for determining whether a driving path of the vehicle is straight or curved. If the driving path is straight, calculating a linear equation of the driving path and outputting to a dynamic control end of a vehicle system. If the driving path is curved, detecting the positioning elements and calculating a curvature of the curved section, a turning speed and a modification angle according to the positions of the positioning elements to enable the dynamic control end to modify the driving speed and the heading angle. The present invention integrates image detection and magnetic track detection, exempted from environment influence and reducing operation cost.

### BACKGROUND OF THE INVENTION

### Field of the Invention

The present invention relates to a detection technology applied to a vehicle, particularly to a virtual track detection system and method.

### Description of the Prior Art

The self-driving bus is a smart traffic device that manufacturers pay much manpower and money to develop. The self-driving bus is a driverless technology able to realize a fully-automatic and high-efficiency shuttle service. The self-driving bus runs on ordinary roads free of physical rails. Therefore, how the self-driving bus advances along a virtual track and how the self-driving bus avoids colliding with passengers and vehicles are the problems need to overcome.

At present, the mainstream technology of self-driving buses is based on GPS navigation and map information, wherein the position of the bus is used to acquire a preliminary GPS positioning, and then map information is used to acquire a precision positioning. However, environment or weather may lead to unstable signal transmission. Another navigation technology is based on Lidar Simultaneous localization and mapping (Lidar SLAM) or virtual SLAM. However, environmental variation may affect the positioning accuracy of the abovementioned navigation technology. Therefore, the base map needs updating periodically, which would increase operation cost and occupy more storage space.

Besides, there is another navigation technology, which uses a camera to capture the image of the track drawn on the road. As shown in FIG. 1, while a vehicle 30 advances in a straight section of a track, the field of view of the camera is sufficient to allow the camera to capture images of the track of a range within several meters before the vehicle 30. As shown in FIG. 2, while the vehicle 30 enters a curved section, the field of view of the camera may be insufficient to allow the camera to capture images of the track, however. In such a situation, the vehicle 30 cannot advance along the track but can only stop or run out of the road. As shown in FIG. 3, the curvature of the curved section is very large, but the field of view of the camera allows the camera to capture image of the track. However, the vehicle system may mistake the track for a stop line or a road boundary in such a scenario. Thus, the vehicle 30 will not keep on advancing along the track.

Accordingly, the present invention proposes a virtual track detection system and method to overcome the abovementioned problems and meet future requirement. The principles and embodiments of the present invention will be described in detail below.

### SUMMARY OF THE INVENTION

One objective of the present invention is to provide a virtual track detection system and method, which integrates an image track and a magnetic track, wherein the vehicle goes along track patterns in a straight section, and wherein track patterns and positioning elements are jointly used to guide the vehicle in a curved section, whereby to avoid recognition failures, such as taking a track pattern as a stop line or a road boundary.

Another objective of the present invention is to provide a virtual track detection system and method, which enables fully autonomous driving, neither needing a driver nor using a GPS navigation technology.

In order to achieve the abovementioned objectives, the present invention provides a virtual track detection system, which comprises a plurality of positioning elements, disposed along a curved section of a track; at least one image capture device, installed in a vehicle and capturing front road images, wherein the front road images include a track pattern of the track; a sensor, installed in the vehicle, and used to detect positions of the positioning elements; and at least one processor, disposed in a vehicle system, connected with the image capture device and the sensor, receiving the front road images, recognizing the track pattern, and determining whether the driving path of the vehicle is straight or curved. If the driving path is straight, the processor works out a linear equation of the driving path and outputs the equation to a dynamic control end of the vehicle system. Then, the dynamic control end drives the vehicle according to the linear equation. If the driving path is curved, the processor works out a curvature of the curved section according to the positions of the positioning elements, and calculates a turning speed and a modification angle according to the curvature, and outputs the turning speed and the modification angle to the dynamic control end. Then, the dynamic control end drives the vehicle according to the turning speed and the modification angle.

In one embodiment, after receiving the front road images, the processor searches the front road images for a plurality of feature points of the track, and recognizes a track pattern according to the feature points of the track.

In one embodiment, the processor takes a center of the head of the vehicle as an origin and lets the center of the vehicle head coincide with the center of the track; next, the processor calculates a linear equation according to the track pattern; then, the processor determines whether the driving path is straight or curved.

In one embodiment, the processor calculates the curvature of the curved section according to the positions of the positioning elements and an image equation; next, the processor calculates the turning speed of the vehicle according to the curvature of the curved section; then, the processor calculates the modification angle according to the curvature of the curved section and the turning speed.

In one embodiment, the dynamic control end includes a transverse control system; the transverse control system controls the angle of the steering wheel according to the modification angle and controls the accelerator and the brake according to the turning speed, whereby to drive the vehicle according to the turning speed and the modification angle.

In one embodiment, the positioning elements are magnetic positioning elements, and the sensor is a magnetic sensor.

The present invention also provides a virtual track detection method, which is applied to a track, wherein a track pattern is drawn on the track; a plurality of positioning elements is disposed along the curved section of the track. While a vehicle runs on the track, the virtual track detection method comprises steps: using at least one image capture device to capture front road images; using at least one processor to receive the front road images and recognize the track pattern, determine whether the driving path of the vehicle is straight or curved according to the track pattern; if the driving path is straight, calculating a linear equation of the driving path and outputting the linear equation to a dynamic control end of a vehicle system to enable the dynamic control end to drive the vehicle according to the linear equation; if the driving path is curved, using a sensor to detect the positioning elements, calculating a curvature of a curved section according to the positions of the positioning elements, using the curvature to calculate a turning speed and a modification angle, outputting the turning speed and the modification angle to the dynamic control end to enable the dynamic control end to drive the vehicle according to the turning speed and the modification angle.

In one embodiment, a step of searching for feature points of the track further includes steps: enclosing an region of interest (ROI) in the front road images; and finding out a group of points having peak color values matching the color values of the feature points of the image.

In one embodiment, a step of calculating a curvature of a curved section according to the positions of the positioning elements further comprises steps: a processor recognizing a scenario according to the track pattern; and using an image equation to calculate the curvature of the curved section according to the track pattern recognized from the front road images and the position of the positioning element that is triggered firstly.

### BRIEF DESCRIPTION OF THE DRAWINGS

FIG. 1 is a diagram schematically showing a field of view of a camera while a vehicle runs along a straight section.

FIG. 2 is a diagram schematically showing a first example of a field of view of a camera while a vehicle runs along a curved section.

FIG. 3 is a diagram schematically showing a second example of a field of view of a camera while a vehicle runs along a curved section.

FIG. 4 is a diagram schematically showing that a vehicle drives along a virtual track of a road according to one embodiment of the present invention.

FIG. 5 is a block diagram schematically a virtual track detection system according to one embodiment of the present invention.

FIG. 6 is a flowchart of a virtual track detection method according to one embodiment of the present invention.

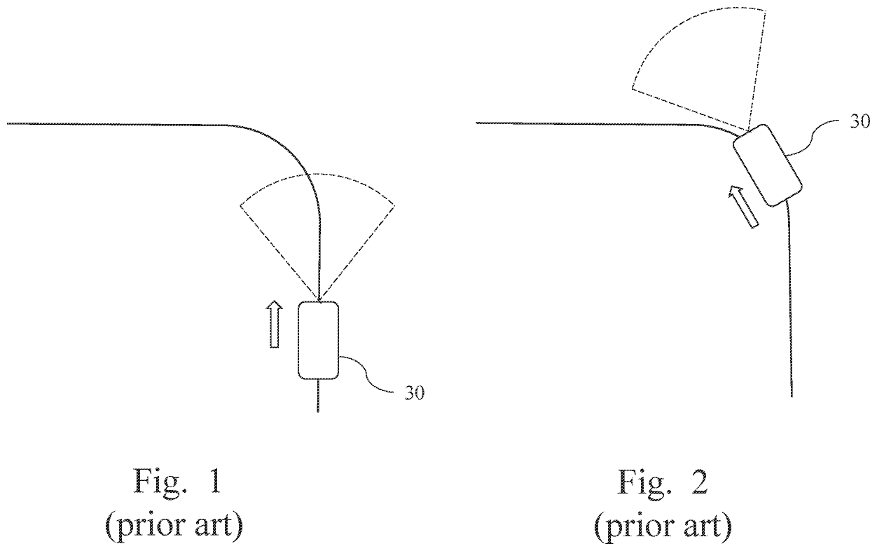

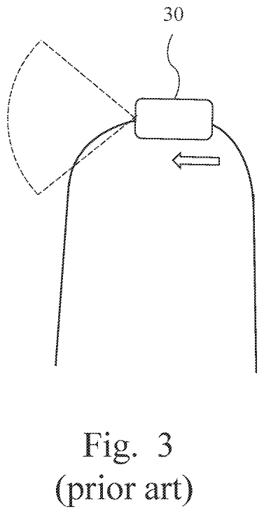

### DETAILED DESCRIPTION OF THE INVENTION

The technical schemes of the embodiments of the present invention will be described clearly and fully in cooperation with the attached drawings. Obviously, the embodiments described in the specification are not all the embodiments of the present invention but only a portion of the embodiments of the present invention. The other embodiments made by the persons skilled in the art according to the technical thoughts of the present invention are regarded as not contributing non-obviousness and are to be also included by the scope of the present invention.

It should be understood: the terms “comprise” and “include” used in the specification and claims only indicate the existence of characteristics, entireties, steps, operations, elements and/or components but do not exclude the existence or addition of one or more other characteristics, entireties, steps, operations, elements and/or components.

It should be also understood: the terms used in the specification of the present invention are only to describe specified embodiments but not to limit the scope of the present invention. While used in the specification and claims of the present invention, the singular noun, which is described by “one”, “one piece of” or “the”, implies the plural form thereof unless the context indicates another condition clearly.

It should be further understood: the term “and/or” used in the specification and claims of the present invention refers to one or several of the listed items or any possible combination of the listed items, and the present invention includes these combinations.

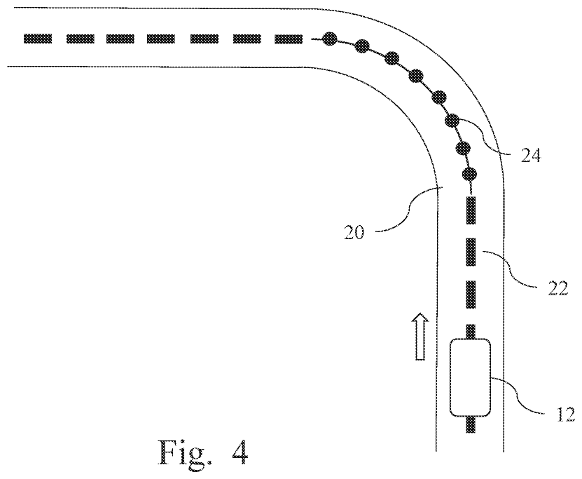

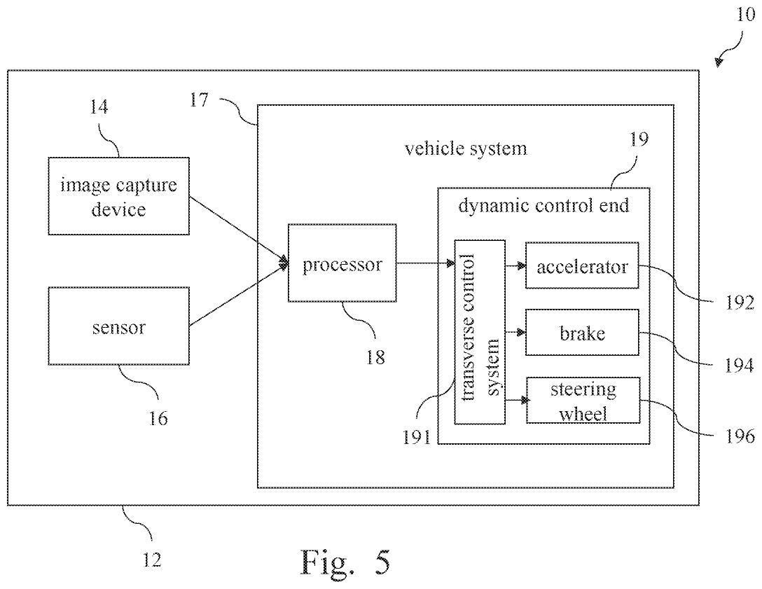

The present invention provides a virtual track detection system. Refer to FIG. 4 and FIG. 5. FIG. 4 is a diagram schematically showing that a vehicle 12 drives on a road 20 along a virtual track according to one embodiment of the present invention. FIG. 5 is a block diagram schematically showing a virtual track detection system 10 according to one embodiment of the present invention. The virtual track detection system 10 involves a vehicle 12 and a track which the vehicle 12 drives along. The vehicle 12 is a self-driving vehicle driving along a virtual track. The virtual track is free of physical rails but in form of a line drawn on a road 20, wherein at least one track pattern 22 is drawn on the road 20 to function as a virtual track. Different track patterns 22 are respectively drawn on different sections of the road 20, such as straight sections, boarding sections, and curved sections. A plurality of positioning elements 24 is disposed on the curved section of the road 20 and used to define the position of the curved section.

At least one image capture device 14, at least one sensor 16, and a vehicle system 17 are disposed in the vehicle 12. The vehicle system 17 includes at least one processor 18 and a dynamic control end 19, which are in signal communication with each other. The dynamic control end 19 has elements for controlling speed and direction, including an accelerator 192, a brake 194, and a steering wheel 196. The image capture device 14 and the sensor 16 are in signal communication with the processor 18. The image capture device 14 and the sensor 16 are installed in the front part of the vehicle 12. The image capture device 14 may be a camera or a video camera, used to capture the front road images which are in front of the vehicle 12. The sensor 16 is used to position the positioning elements 24. The processor 18 is disposed in the vehicle system 17 of the vehicle 12. The processor 18 receives the front road images captured by the image capture device 14 and recognizes the track patterns 22 of the road 20 from the front road images. The processor 18 determines whether the driving path of the vehicle 12 is straight or curved according to the track patterns 22, whereby the processor 18 can switch to a straight-track mode or a curved-track detection mode.

If the driving path of the vehicle 12 is straight, the processor 18 starts the straight-track mode. In such a case, the processor 18 calculates a linear equation of the driving path and outputs the linear equation to the dynamic control end 19 of the vehicle system 17. Then, the dynamic control end 19 drives the vehicle 12 according to the linear equation. The linear equation is expressed by Equation (1), which is a binary quadric error equation.

$$Er {r}_{i} = {x}_{i} - ( a + b {y}_{i} + c {y}_{i}^{2} )$$

$$wherein$$

$$\{ \begin{matrix}\frac{\partial E}{\partial a} = - 2 \sum ( {x}_{i} - a - b {y}_{i} - c {y}_{i}^{2} ) = 0 \\ \frac{\partial E}{\partial b} = - 2 \sum ( {y}_{i} {x}_{i} - a {y}_{i} - b {y}_{i}^{2} - c {y}_{i}^{3} ) = 0 \\ \frac{\partial E}{\partial c} = - 2 \sum ( {y}_{i}^{2} {x}_{i} - a {y}_{i}^{2} - b {y}_{i}^{3} - c {y}_{i}^{4} ) = 0\end{matrix} \qquad ( 1 )$$

wherein three simultaneous equations are used to calculate three coefficients α, b, and c.

In detail, a traffic lane has two traffic lane markings: the left traffic lane marking and the right traffic lane marking; the positions (xᵢ, γᵢ) of the feature points of the left and right traffic lane markings in the vehicular coordinate system may be substituted into Equation (1) to work out the values of α, b, and c, whereby are acquired the equation of the left traffic lane marking and the equation of the right traffic lane marking. Next, the processor 18 performs the fitting of the equation of the left traffic lane marking and the equation of the right traffic lane marking and uses a reliability analysis and a logic analysis to exclude erroneous information (such as incorrect feature points or non-traffic lane feature points), whereby to establish a traffic lane model. Then, the dynamic control end 19 drives the vehicle 12 according to the traffic lane model.

If the driving path is curved, the processor 18 switches to the curved-track detection mode. The processor 18 calculates a curvature of a curved section according to the positions of the positioning elements 24. If the curved section has a larger curvature, the turning speed should be decreased lest the vehicle overturn or run out of the road. Therefore, it is necessary to calculate a turning speed and a modification angle according to the curvature of the curved section. The modification angle is the turning angle of the vehicular head, i.e. the steering angle of the steering wheel. The processor 18 uses the modification angle to control the heading angle of the vehicle 12. Next, the processor 18 outputs the turning speed and the modification angle to the dynamic control end 19. Then, the dynamic control end 19 drives the vehicle 12 according to the turning speed and the modification angle.

In one embodiment, the sensor 16 is a magnetic sensor used to detect the positioning elements 24; the positioning elements 24 are magnetic pins or other magnetic elements.

The positioning elements 24 are disposed along the central line of the curved section. The distances between two adjacent positioning elements 24 are not necessarily the same. For example, if the curved section has a larger curvature, the track patterns 22 may not be within the field of view of the image capture device 14, as shown in FIG. 2. In such a case, although the sensor 16 can still detect the positioning elements 24 in the curved section, the vehicle 12 may need to turn left by 3 degrees so as to detect the next positioning element 24. However, the vehicle 12 may run too fast to complete turning in time and thus run out of the road. Therefore, while the curved section has a larger curvature, the distance between the adjacent positioning elements 24 should be shortened so as to increase the density of the positioning elements 23. Further, the turning speed of the vehicle 12 should be also decreased lest the vehicle 12 is too late to complete turning while the sensor 16 detects the positioning element 24.

In one embodiment, the dynamic control end 19 includes a transverse control system 191; the transverse control system 191 is connected with the accelerator 192, the brake 194, and the steering wheel 196; the transverse control system 191 is in signal communication with the processor 18 and controls the angle of the steering wheel 196 of the vehicle 12 according to the modification angle. Besides, the transverse control system 191 controls the accelerator 192 and the brake 194 according to the turning speed, whereby to enhance the driving safety of the vehicle 12.

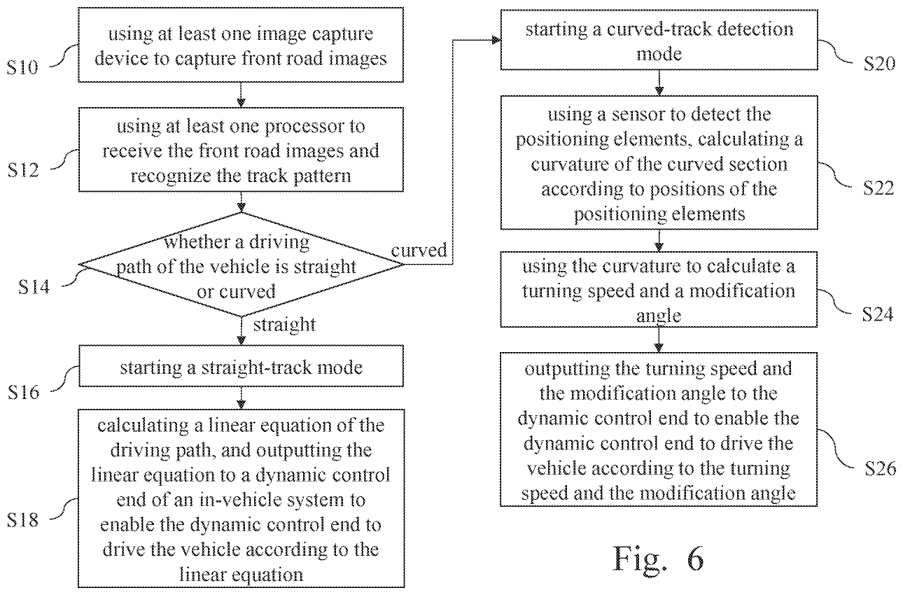

Below is described in detail the method of using the virtual track detection system of the present invention. Refer to FIG. 6, which is a flowchart of a virtual track detection method according to one embodiment of the present invention. Firstly, in step S10, while a vehicle 12 drives on a track, use an image capture device 14 to capture front road images (the images of the road in front of the vehicle), including other vehicles, traffic signs, passengers, and track patterns. Next, in Step S12, use at least one processor 18 to receive the front road images and recognize the track patterns. In detail, the processor 18 recognizes the track patterns from the front road images via using an image-processing algorithm to filter out the non-tract objects, such as the passengers, the street trees, the traffic signs, find out a plurality of feature points that can represent the track, and then join the feature points to form a track pattern. Next, in Step S14, the processor 18 determines whether the driving path of the vehicle 12 is straight or curved.

If the driving path of the vehicle 12 is straight, the process proceeds to Step S16 and Step S18. In Step S16, the processor 18 starts a straight-track mode. In Step S18, the processor 18 works out a linear equation of the driving path and outputs the linear equation to a dynamic control end 19 of a vehicle system 17, whereby the dynamic control end 19 can drive the vehicle 12 according to the linear equation.

If the driving path of the vehicle 12 is curved, the process proceeds to Steps S20-S24. In Step S20, the processor 18 starts a curved-track detection mode. In Step S22, the processor 18 uses a sensor 16 to detect positioning elements 24 and calculates a curvature of a curved section according to the positions of the positioning elements 24. In Step S24, the processor 18 uses the curvature of the curved section to calculate a turning speed and a modification angle, wherein the processor 18 calculates the turning speed of the vehicle 12 firstly to prevent the vehicle 12 from being too late to complete turning and running out of the road; next, the processor 18 calculates the modification angle according to the curvature of the curved section and the turning speed. In Step S26, the processor 18 outputs the turning speed and the modification angle to the dynamic control end 19, whereby the dynamic control end 19 can drive the vehicle 12 according to the turning speed and the modification angle; for example, the dynamic control end 19 may release an accelerator 192 and control a brake 194 to decelerate the vehicle 12 or control the steering wheel 196 to change the direction of the vehicle 12.

In one embodiment, in Step S12, the processor 18 finds out the plurality of feature points of the track with a method including steps: enclosing an region of interest (ROI) in the front road image (for example, enclosing a region of the ground); and finding out a group of points having peak color values matching the color values of the feature points of the image. In the case of traffic lane markings, the traffic lane markings are white, whose RGB values are close to (250, 250, 250) in the color table; the ground is black; however, the ground is not fully black in a normal detection condition and thus has RGB values close to (10, 10, 10) in the color table. Then, the feature points of the track can be found via detecting the peak color values in the image and finding out the points whose color values are close to the color values of the track lane markings.

In one embodiment, in Step S14, the processor 18 determines whether the driving path is straight or curved with the steps: taking the center of the head of the vehicle 12 as an origin and letting the center of the head of the vehicle 12 coincide with the center of the track; calculating a linear equation according to the track pattern 22; determining whether the driving path is straight or curved according to the linear equation. If the driving path is a curved path, the linear equation would not be an equation of a straight line but will be an equation of a special path.

In one embodiment, in order to enable the processor 18 to determine whether the driving path is straight or curved in Step S14, special icons are drawn on the track patterns. As long as the processor 18 can recognize the special icons, the processor 18 would know that the vehicle 12 will go in a curved section or go into/out of a station. Thus, it is unnecessary to calculate the linear equation.

In one embodiment, Step S22 further includes the following steps: the processor 18 recognizing a scenario according to the track pattern 22, such as a scenario of a curved section or a scenario of going into/out of a station; and using an image equation to calculate the curvature of the curved section according to the position of the positioning element that is triggered firstly and the front road image, whereby to modify the heading angle of the vehicle 12. The image equation uses the least square method to calculate the linear equation of the driving path. The linear equations of the left and right traffic lane markings are worked out and then fitted to acquire the linear equation α+bγᵢ+cγᵢ² of the central line of the driving path (i.e., the track pattern), wherein the coefficient c is the curvature of the curved section; the coefficient b is the straight line; the coefficient α is a constant. Then, a differential operation is performed on the linear equation to obtain the curvature of the curved section.

In the present invention, special icons may be drawn to function as the track patterns. The icons and the positioning elements enable the vehicle to go into/out of a station precisely. For example, special icons are drawn in the entrance and exit of a station, and the positioning elements are disposed more densely, such as one positioning element per 10 cm. Once the special icon enters the field of view of the image capture device, the vehicle learns in advance that it will go into the station. While the sensor detects the first positioning element, the vehicle determines that it has gone into the station now and is going to arrive at the docking position.

The present invention integrates the patterned track and the magnetic track to guide the vehicle 12. In the straight section, the vehicle 12 drives along the track patterns. While the path changes (in a curved section), the image navigation and the magnetic navigation are integrated. On one hand, the vehicle detects the front road image to predict that there is a turning ahead; for example, the vehicle views the front road image to see whether the track patterns are in form of a straight line or whether there are special icons. On the other hand, the vehicle detects the positions of the positioning elements to modify the track of the driving path and configure the heading angle. Even in the intersection free of track patterns, the positioning elements can still enable the vehicle to drive autonomously. In the conventional technology, while the curved section has a very larger curvature or the state of the road is very complicated, the GPS signals and the surveillance of a driver must be used simultaneously lest detection errors occur. For example, the curved section is mistaken for a stop line or a road boundary and thus filtered out. The present invention can realize fully autonomous driving, neither needing the driver's surveillance nor needing the GPS navigation. The present invention can solve the problem of detection errors as long as the positioning elements are more densely disposed in the curved section or the intersection free of the track patterns.

In conclusion, the present invention provides a virtual track detection system and method, which integrates image tracks and magnetic tracks. In a straight section, the vehicle drives along the track patterns. In a special scenario, such as approaching a curved section or a station, the vehicle will switch to a curved-track detection mode at appropriate timing to detect the front road image and predict that there is a turning ahead. In the present invention, even though the path varies greatly, the vehicle would not mistake a curved section for a stop line or a road boundary but can still advance stably.

The embodiments described above are only to exemplify the present invention but not to limit the scope of the present invention. Any equivalent modification or variation according to the characteristics or spirit of the present invention is to be also included by the scope of the present invention.

What is claimed is:

1. A virtual track detection system, comprising:
a plurality of positioning elements, disposed along a curved section of a track;
at least one image capture device, installed in a vehicle and capturing front road images, wherein the front road images include a track pattern of the track;
a sensor, installed in the vehicle, and used to detect positions of the positioning elements; and
at least one processor, disposed in a vehicle system, connected with the at least one image capture device and the sensor,
wherein the at least one processor receives the front road images, recognizes the track pattern, and determines whether a driving path of the vehicle is straight or curved, and
wherein if the driving path is straight, the at least one processor works out a linear equation of the driving path and outputs the linear equation to a dynamic control end of the vehicle system; then the dynamic control end drives the vehicle according to the linear equation, and
wherein if the driving path is curved, the at least one processor works out a curvature of the curved section according to the positions of the positioning elements, calculates a turning speed and a modification angle according to the curvature, and outputs the turning speed and the modification angle to the dynamic control end; then the dynamic control end drives the vehicle according to the turning speed and the modification angle.

2. The virtual track detection system according to claim 1, wherein after receiving the front road images, the at least one processor searches the front road images for a plurality of feature points of the track and recognizes the track pattern according to the feature points of the track.

3. The virtual track detection system according to claim 1, wherein the at least one processor takes a center of a head of the vehicle as an origin and lets the center of the head of the vehicle coincide with a center of the track; next, the at least one processor calculates the linear equation according to the track pattern; then, the processor determines whether the driving path is straight or curved.

4. The virtual track detection system according to claim 1, wherein the at least one processor calculates the curvature of the curved section according to the positions of the positioning elements and an image equation; the at least one processor calculates the turning speed of the vehicle according to the curvature of the curved section; the at least one processor calculates the modification angle according to the curvature of the curved section and the turning speed.

5. The virtual track detection system according to claim 1, wherein the dynamic control end includes a transverse control system; the transverse control system controls an angle of a steering wheel of the vehicle according to the modification angle and controls an accelerator of the vehicle and a brake of the vehicle according to the turning speed; the vehicle drives according to the turning speed and the modification angle.

6. The virtual track detection system according to claim 1, wherein the positioning elements are magnetic positioning elements, and the sensor is a magnetic sensor.

7. A virtual track detection method, which is applied to a track, wherein a track pattern is drawn on the track; a plurality of positioning elements is disposed along a curved section of the track, and wherein while a vehicle runs on the track, the virtual track detection method comprises steps:
using at least one image capture device to capture front road images;
using at least one processor to receive the front road images, recognize the track pattern, and determine whether a driving path of the vehicle is straight or curved according to the track pattern;
calculating a linear equation of the driving path if the driving path is straight, and outputting the linear equation to a dynamic control end of a vehicle system to enable the dynamic control end to drive the vehicle according to the linear equation;
using a sensor to detect the positioning elements if the driving path is curved, calculating a curvature of the curved section according to positions of the positioning elements, using the curvature to calculate a turning speed and a modification angle, outputting the turning speed and the modification angle to the dynamic control end to enable the dynamic control end to drive the vehicle according to the turning speed and the modification angle.

8. The virtual track detection method according to claim 7, wherein after receiving the front road images, the at least one processor searches the front road images for a plurality of feature points of the track and recognizes the track pattern according to the feature points of the track.

9. The virtual track detection method according to claim 8, wherein the step of searching the front road images for a plurality of feature points of the track includes steps:
enclosing a region of interest (ROI) in the front road images; and
finding out a group of points having peak color values matching color values of the feature points.

10. The virtual track detection method according to claim 7, wherein the at least one processor takes a center of a head of the vehicle as an origin and lets the center of the head of the vehicle coincide with a center of the track; next, the at least one processor calculates the linear equation according to the track pattern; then, the processor determines whether the driving path is straight or curved.

11. The virtual track detection method according to claim 7, wherein the at least one processor calculates the curvature of the curved section according to the positions of the positioning elements and an image equation; the at least one processor calculates the turning speed of the vehicle according to the curvature of the curved section; the at least one processor calculates the modification angle according to the curvature of the curved section and the turning speed.

12. The virtual track detection method according to claim 7, wherein the dynamic control end includes a transverse control system; the transverse control system controls an angle of a steering wheel of the vehicle according to the modification angle and controls an accelerator of the vehicle and a brake of the vehicle according to the turning speed; the vehicle drives according to the turning speed and the modification angle.

13. The virtual track detection method according to claim 7, wherein the step of calculating the curvature of the curved section according to the positions of the positioning elements includes steps:
the at least one processor recognizing a scenario according to the track pattern; and
using an image equation to calculate the curvature of the curved section according to the track pattern recognized from the front road images and a position of the positioning element that is triggered firstly.
